(19) United States
(12) Patent Application Publication
(10) Pub. No.: US 2026/0166958 A1
(43) Pub. Date: Jun. 18, 2026

(54) Heat pump with Hot Gas Bypass for Automotive Heat Pump Application

(71) Applicant: Hanon Systems, Daejeon (KR)

(72) Inventors: Minwoong Kang, Novi, MI (US); Daniel Lumley, Livonia, MI (US); Jongyeong Byun, Rochester Hills, MI (US); Jim Tasiopoulos, West Bloomfield, MI (US); Evangelos S. Papoulis, Northville, MI (US)

(21) Appl. No.: 19/384,574

(22) Filed: Nov. 10, 2025

Related U.S. Application Data
(60) Provisional application No. 63/733,808, filed on Dec. 13, 2024.
(60) Provisional application No. 63/733,835, filed on Dec. 13, 2024.

(51) Int. Cl. B60H 1/00; F25B 30/02; F25B 41/20; F25B 49/02

(52) U.S. Cl. CPC B60H 1/00914; F25B 30/02; F25B 41/20; F25B 49/02; F25B 2600/2501; F25B 2700/21

(57) ABSTRACT

A heat pump system includes a refrigerant circuit having a primary loop including a compressor, a condenser, an expansion element, and a chiller, wherein a bypass flow path extends from a branch point disposed along the primary loop downstream of the compressor and upstream of the condenser to one of a pre-chiller reentry point disposed along the primary loop downstream of the expansion element and upstream of the chiller or a post-chiller reentry point disposed along the primary loop downstream of the chiller and upstream of a suction inlet of the compressor. A bypass valve is disposed along the bypass flow path and is configured to meter a flow of gaseous refrigerant flowing along the bypass flow path to the corresponding one of the pre-chiller reentry point or the post-chiller reentry point to increase a pressure and temperature of the refrigerant along the primary loop.

### CROSS-REFERENCE TO RELATED APPLICATIONS

This patent application claims priority to U.S. Provisional Patent Application Ser. No. 63/733,808, filed on Dec. 13, 2024, and U.S. Provisional Patent Application Ser. No. 63/733,835, filed on Dec. 13, 2024, wherein the entirety of the disclosure of each identified provisional patent application is hereby incorporated herein by reference.

### FIELD OF THE INVENTION

The present invention relates to a heat pump system for automotive applications, and more particularly, to a heat pump system utilizing a hot gas bypass flow path introduced into a refrigerant circuit of the heat pump system.

### BACKGROUND

It has become increasingly common for vehicles to utilize the heat generated by the compression of a refrigerant along a refrigerant circuit of the vehicle in order to heat the passenger cabin thereof, such as may be necessary in electric vehicles where the heat generated by internal combustion of fuel is not available for such a purpose. It is also common for such refrigerant circuits to be incorporated into heat pump systems whereby additional fluid circuits are in heat exchange relationship with the refrigerant circuit in order to transfer heat to or from the refrigerant at various positions along the refrigerant circuit. These additional fluid circuits may in turn be associated with heating and/or cooling the passenger cabin of the vehicle or with regulating the temperature of various components of the vehicle, such as heat generating electronic components thereof, among other possibilities.

FIG. 1 illustrates one possible heat pump system 1 where a refrigerant circuit 11 thereof includes a condenser 14 in heat exchange communication with a first fluid circuit 31 circulating a coolant associated with heating the passenger compartment of the vehicle as well as an evaporator/chiller 18 in heat exchange communication with a second fluid circuit 41 having a coolant in heat exchange relationship with the ambient air. The refrigerant circuit 11 includes a compressor 12, a refrigerant side 14a of the condenser 14, a receiver drier 15, and a refrigerant side 18a of the chiller 18. The first fluid circuit 31 includes a coolant side 14b of the condenser 14, a pump 32, an auxiliary heating device 33, and an HVAC heater core (heat exchanger) 34. The second fluid circuit 41 includes a coolant side 18b of the chiller 18, an outside heat exchanger (OHX) 44, and a pump 42. According to FIG. 1, the heat pump system 1 provides comfort to the passenger cabin by transferring heat from the compressed refrigerant to the coolant (water) of the first fluid circuit 31 via the (water cooled) condenser 14, which in turn transfers heat to the air delivered to the passenger cabin via the HVAC heater core 34, where the temperature of the air used to heat the passenger compartment is designated as T_{H} in FIG. 1. The refrigerant circuit 11 also includes heat being transferred to the refrigerant from the coolant of the second fluid circuit 41 via the chiller 18, which in turn results in the heating capacity of the refrigerant circuit 11 being partially dependent on the ambient air temperature T_{A} due to the coolant of the second fluid circuit 41 being in heat exchange communication with the ambient air via the OHX 44.

Desired operation of the heat pump system 1 as shown and described requires the ambient air temperature T_{A} to exceed the temperature of the coolant T_{C} of the second fluid circuit 41 entering the OHX 44 in order to draw heat from the ambient air. However, one problem that may occur with respect to such a heat pump system 1 is that when ambient air temperatures are especially low, it becomes difficult for the heat pump system 1 to provide sufficient heating, and especially without undesirably freezing the OHX 44 of the second fluid circuit 41 associated with providing the heat exchange communication of the coolant with the ambient air. In some circumstances, the difference in temperature between the coolant of the second fluid circuit 41 and the ambient air temperature T_{A} may be required to be maintained at a relatively small value of around 5° C. or under to minimize the occurrence of freezing of a surface of the OHX 44. These conditions result in a lack of enough heat energy to adequately heat the passenger cabin absent the use of the auxiliary heating device 33, which adds complexity and cost to the associated heat pump system 1. As another negative, the described conditions lead to the heating capacity of the compressor 12 of the refrigerant circuit 11 being lowered significantly due to the introduction of the refrigerant at an especially low suction temperature T_{S}.

Additionally, the desired operation of the heat pump system 1 as shown and described may require the suction pressure P_{S} at the suction end of the compressor 12 to exceed a predetermined pressure value, such as 1 bar, to ensure that oil is properly circulated within the compressor 12 while also operating the compressor 12 at a maximized possible speed in order to improve the energy generation of the compressor 12. However, one problem that may occur with respect to such a heat pump system 1 is that when ambient air temperatures T_{A} are especially low, it becomes difficult for the heat pump system 1 to provide sufficient heating without generating a vacuum in the suction pressure P_{S}. The compressor speed (RPM) is typically constrained by the suction pressure P_{S}, which can in turn lead to very low oil circulation within the compressor 12, increased discharge temperatures, and reduced heating efficiency in low temperature ambient air T_{A} conditions, thus not fully optimizing heat transfer of the system 1 to the cabin.

It would thus be desirable to provide a heat pump system having the ability to provide sufficient heating capacity in a heating mode of operation when experiencing relatively low ambient air temperatures without causing a freezing of the associated OHX of the heat pump system. It would additionally be desirable to provide a heat pump system having the ability to provide sufficient heating capacity in a heating mode of operation when experiencing relatively low ambient air temperatures without generating a vacuum in the suction pressure of the compressor of the heat pump system.

### SUMMARY OF THE INVENTION

In accordance with the present disclosure, an improved heat pump system having a refrigerant circuit with a hot gas bypass has surprisingly been discovered.

According to an embodiment of the present invention, a heat pump system includes a refrigerant circuit having a primary loop including, in a direction of flow of a refrigerant through the primary loop, a compressor, a condenser, an expansion element, and a chiller, wherein a bypass flow path extends from a branch point disposed along the primary loop downstream of the compressor and upstream of the condenser to one of a pre-chiller reentry point disposed along the primary loop downstream of the expansion element and upstream of the chiller, or a post-chiller reentry point disposed along the primary loop downstream of the chiller and upstream of a suction inlet of the compressor. A bypass valve is disposed along the bypass flow path and is configured to meter a flow of gaseous refrigerant flowing along the bypass flow path to the corresponding one of the pre-chiller reentry point or the post-chiller reentry point with the flow of the gaseous refrigerant configured to increase a pressure and temperature of the refrigerant along the primary loop at the corresponding one of the pre-chiller reentry point or the post-chiller reentry point.

A method of operating a heat pump system according to the present invention is also disclosed. The method includes the steps of providing a refrigerant circuit having a primary loop including, in a direction of flow of a refrigerant through the primary loop, a compressor, a condenser, an expansion element, and a chiller, wherein a bypass flow path extends from a branch point disposed along the primary loop downstream of the compressor and upstream of the condenser; and metering a flow of gaseous refrigerant along the bypass flow path to one of a pre-chiller reentry point disposed along the primary loop downstream of the expansion element and upstream of the chiller or a post-chiller reentry point disposed along the primary loop downstream of the chiller and upstream of a suction inlet of the compressor, wherein the gaseous refrigerant increases a pressure and temperature of the refrigerant along the primary loop at the corresponding one of the pre-chiller reentry point or the post-chiller reentry point to which the gaseous refrigerant is bypassed.

### BRIEF DESCRIPTION OF THE DRAWINGS

FIG. 1 is a schematic representation of a heat pump system requiring an auxiliary heating device to meet the heating demands of the passenger cabin;

FIG. 2 is a schematic representation of a heat pump system according to an embodiment of the present invention, wherein a refrigerant circuit of the heat pump system includes a hot gas bypass for regulating the temperature of an OHX of the refrigerant circuit;

FIG. 3 is a flow chart showing a method of operation of the heat pump system of FIG. 2;

FIG. 4 is a schematic representation of the heat pump system according to another embodiment of the present invention where the configuration of the heat pump system of FIG. 2 is incorporated into a heat pump system for use with a vehicle having an internal combustion engine (ICE);

FIG. 5 is a schematic representation of a heat pump system according to another embodiment of the present invention, wherein the refrigerant circuit of the heat pump system includes a hot gas bypass for regulating the suction pressure of the compressor of the refrigerant circuit;

FIG. 6 is a flow chart showing a method of operation of the heat pump system of FIG. 5;

FIG. 7 is a chart showing benchmark testing trends of the heat pump system of FIG. 5 when utilizing the hot gas bypass feature thereof;

FIG. 8 is a schematic representation of the heat pump system according to another embodiment of the present invention where the configuration of the heat pump system of FIG. 5 is incorporated into a heat pump system for use with a vehicle having an ICE;

FIG. 9 is a schematic representation of a heat pump system according to another embodiment of the present invention, wherein the refrigerant circuit of the heat pump system includes a hot gas bypass for regulating both the temperature of the OHX of the refrigerant circuit and the suction pressure of the compressor of the refrigerant circuit;

FIG. 10 is a flow chart showing a method of operation of the heat pump system of FIG. 9; and

FIG. 11 is a schematic representation of the heat pump system according to another embodiment of the present invention where the configuration of the heat pump system of FIG. 9 is incorporated into a heat pump system for use with a vehicle having an ICE.

### DETAILED DESCRIPTION OF THE INVENTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

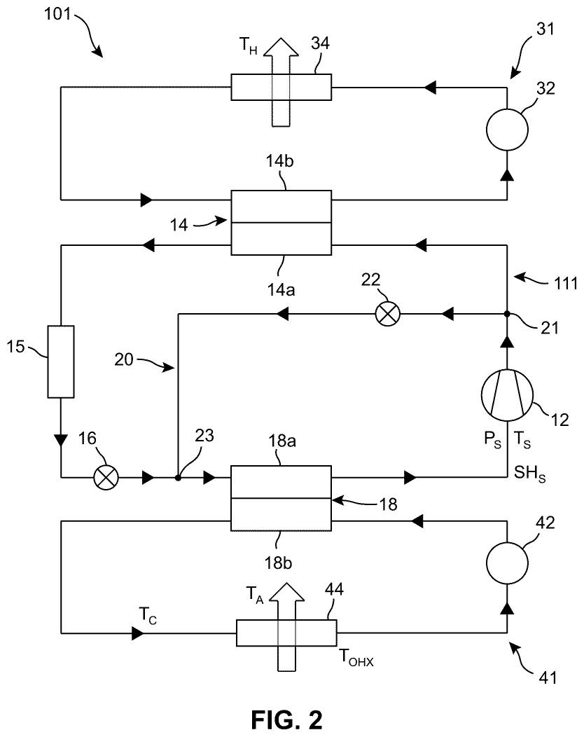

FIG. 2 schematically illustrates a heat pump system 101 according to an embodiment of the present invention, wherein the heat pump system 101 may be integrated into an associated vehicle having a passenger cabin. The heat pump system 101 generally includes a refrigerant circuit 111, a first coolant circuit 31 in heat exchange communication with the refrigerant circuit 111, and a second coolant circuit 41 in heat exchange communication with the refrigerant circuit 111. In some embodiments, the first coolant circuit 31 and the second coolant circuit 41 are independently provided, and in other embodiments the first coolant circuit 31 and the second coolant circuit 41 are fluidly coupled to one another or are selectively fluidly coupled to one another, as needed for achieving the objectives of the corresponding heat pump system 101.

The refrigerant circuit 111 includes, in an order of flow of a refrigerant through a primary loop of the refrigerant circuit 111, a compressor 12, a condenser 14, a receiver drier (RD) 15, an expansion element 16, and an evaporator/chiller (hereinafter “chiller”) 18, each of which operates in conventional fashion during circulation of the refrigerant through the primary loop. The refrigerant circuit 111 also includes a bypass flow path 20 for the refrigerant to flow along after having exited a discharge end of the compressor 12 with the refrigerant bypassing the condenser 14, RD 15, and expansion element 16 to join with the refrigerant having exited the expansion element 16 while still provided as a relatively high temperature and high pressure gas. The bypass flow path 20 extends from a first branch point 21 of the primary loop disposed downstream of the discharge end of the compressor 12 and upstream of the condenser 14 to a reentry point 23 of the primary loop disposed downstream of the expansion element 16 and upstream of an inlet side of the chiller 18. The bypass flow path 20 includes a bypass valve 22 thereon for controlling a flow of the refrigerant exiting the compressor 12 and flowing through the bypass flow path 20. The valve 22 may be an expansion valve that is variably adjustable to adjust a flow cross-section through the valve 22, and therefore a flow rate of the refrigerant flowing through the valve 22 as well as a distribution of the refrigerant flowing through the valve 22 in comparison to the refrigerant flowing along the primary loop towards the condenser 14. The valve 22 may be considered to be a flow metering valve of the bypass flow path 20. The valve 22 may be adjustable to be fully closed, partially open at any number of intermediate positions, and fully open for allow for maximized flow therethrough. The adjustment of the valve 22 may also be performed to adjust the pressure (and to a lesser extent the temperature) of the refrigerant exiting the valve 22 and reaching the reentry point 23 for passage through the chiller 18, as needed.

The refrigerant circuit 111 may include additional components or flow paths relative to those shown and described while remaining within the scope of the present invention, so long as the same basic flow and heat exchange relationships are maintained as described herein with respect to at least certain modes of operation of the corresponding heat pump system 101 and in a manner in accordance with the benefits of the presently disclosed invention.

The first coolant circuit 31 includes a first coolant, such as water, that is circulated through a loop including, in a direction of flow of the first coolant, a pump 32 causing the circulation of the first coolant, an HVAC heater core (heat exchanger) 34 associated with exchanging heat between the first coolant and air delivered to the passenger cabin of the vehicle, and the condenser 14, which may be a water cooled condenser 14 in the present example. The condenser 14 may be referred to as including a refrigerant side 14a exposed to the refrigerant of the refrigerant circuit 111 and a coolant side 14b exposed to the first coolant of the first coolant circuit 31 herein, whereby the condenser 14 provides heat exchange communication between the refrigerant of the refrigerant circuit 111 and the first coolant of the first coolant circuit 31.

The second coolant circuit 41 includes a second coolant that is circulated through a loop including, in a direction of flow of the second coolant, a pump 42 causing the circulation of the second coolant, the chiller 18, and an outside heat exchanger (OHX) 44 associated with exchanging heat with ambient air at an ambient air temperature T_{A}. The chiller 18 may be referred to as including a refrigerant side 18a exposed to the refrigerant of the refrigerant circuit 111 and a coolant side 18b exposed to the second coolant of the second coolant circuit 41 herein, whereby the chiller 18 provides heat exchange communication between the refrigerant of the refrigerant circuit 111 and the second coolant of the second coolant circuit 41.

It should be readily apparent that each of the coolant circuits 31, 41 may include additional components and flow configurations in addition to those shown while remaining within the scope of the present invention, so long as the same basic flow and heat exchange relationships are maintained as described herein with respect to at least certain modes of operation of the corresponding heat pump system and in a manner in accordance with the benefits of the presently disclosed invention.

The heat pump system 101 may further include any combination of a sensor to monitor a suction temperature T_{S} of the refrigerant entering a suction end of the compressor 12, a sensor to monitor a suction pressure P_{S} of the refrigerant entering the suction end of the compressor 12, a sensor to monitor a temperature of the refrigerant when entering or exiting the chiller 18, a sensor to monitor a pressure of the refrigerant when entering or exiting the chiller 18, a sensor to monitor a temperature of the second coolant when entering or exiting the chiller 18, a sensor to monitor a temperature of the second coolant entering, exiting, or within the OHX 44 and/or a temperature of the OHX 44 itself (or a surface thereof subjected to icing), a sensor to monitor a temperature T_{H} of the heated air to be delivered to the passenger cabin of the vehicle, and/or a sensor to monitor the ambient air temperature T_{A}. These sensors may be utilized in determining operation of the heat pump system 101 with respect to factors such as the ambient air temperature and the selected mode of operation of the heat pump system 101. All such sensors may be in signal communication with a corresponding controller of the heat pump system 101, which includes the necessary computing components to apply a desired control scheme when operating the heat pump system 101. The controller may further be in signal communication with all necessary components of the heat pump system 101 in need of actuatable control, such as the compressor 12, the expansion element 16, and the bypass valve 22, wherein it is assumed hereinafter that the activation or actuation of any associated components occurs as a result of a signal of the described controller following a determination made by the controller in accordance with a corresponding control scheme.

The expansion element 16 may be configured as a variably adjustable valve, such as an electronic expansion valve (EXV), and is configured to be in signal communication with the controller of the heat pump system 101. The expansion element 16 is operable to regulate a pressure and/or temperature of the refrigerant discharged therethrough prior to entry into the chiller 18 by adjusting a flow cross-section of the expansion element 16. The controller may adjust the expansion element 16 in real-time in response to monitored operating conditions of the heat pump system 101, such as by the aforementioned sensors, in order to meet a desired performance target. In certain modes of operation, the expansion element 16 may be controlled by the controller to influence or regulate a suction superheat value (SH_{S}) of the refrigerant entering the suction end of the compressor 12.

The suction superheat SH_{S} refers to the temperature differential between the measured suction temperature T_{S} of the refrigerant entering the compressor 12 and the saturation temperature of the refrigerant corresponding to the measured suction pressure P_{S}. A target SH_{S} value may be defined by the controller based on system performance parameters, and the controller may be configured to dynamically adjust the expansion element 16 to cause the measured SH_{S} to approach or match the target SH_{S} value. In some embodiments, the control of the suction superheat may equivalently be expressed in terms of a comparison between a target suction temperature and the measured suction temperature T_{S} of the refrigerant, wherein the target suction temperature corresponds to a desired superheat value above the saturation temperature of the refrigerant at the corresponding suction pressure P_{S}. By metering the refrigerant flow across the expansion element 16, the controller is able to affect the degree of refrigerant evaporation and associated heat absorption occurring upstream of the compressor 12, thereby controlling the temperature and phase composition of the refrigerant entering the compressor and enabling optimization of compressor operation and system efficiency under varying ambient and load conditions.

The heat pump system 101 operates as follows upon the opening of the bypass flow path 20 via the valve 22 being at least partially opened to allow for flow of the high temperature and high pressure refrigerant from the branch point 21 to the reentry point 23 for passage through the chiller 18 and then reentry into the suction end of the compressor 12. The refrigerant flows through the bypass flow path 20 and joins the refrigerant entering the chiller 18 from the primary loop of the refrigerant circuit 111, which has been reduced in temperature and pressure via the operation of the condenser 14 and the expansion element 16. The relatively high temperature and pressure refrigerant from the bypass flow path 20 accordingly heats the refrigerant passing through the refrigerant side 18a of the chiller 18 such that the suction temperature T_{S} of the refrigerant entering the suction end of the compressor 12 is increased relative to operation of the refrigerant circuit 111 absent flow of the refrigerant through the bypass flow path 20. This increased temperature of the refrigerant increases the suction pressure P_{S} of the refrigerant in a manner allowing for the compressor 12 to be operated at a greater speed (RPM) for increasing the temperature of the refrigerant when reaching the condenser 14 along the primary loop, thereby increasing the temperature T_{H} of the air delivered to the passenger cabin via the first coolant and the heater core 34 of the first coolant circuit 31. The use of the bypass flow path 20 accordingly increases the heating capacity of the heat pump system 101.

The heating of the refrigerant within the refrigerant side 18a of the chiller 18 also leads to an increase in the temperature of the second coolant exiting the coolant side 18b of the chiller 18, which in turn leads to the second coolant having an increased temperature when passing through the OHX 44 of the second coolant circuit 41. This form of heating of the second coolant accordingly prevents an incidence of freezing of the OHX 44 when exposed to especially low ambient air temperatures.

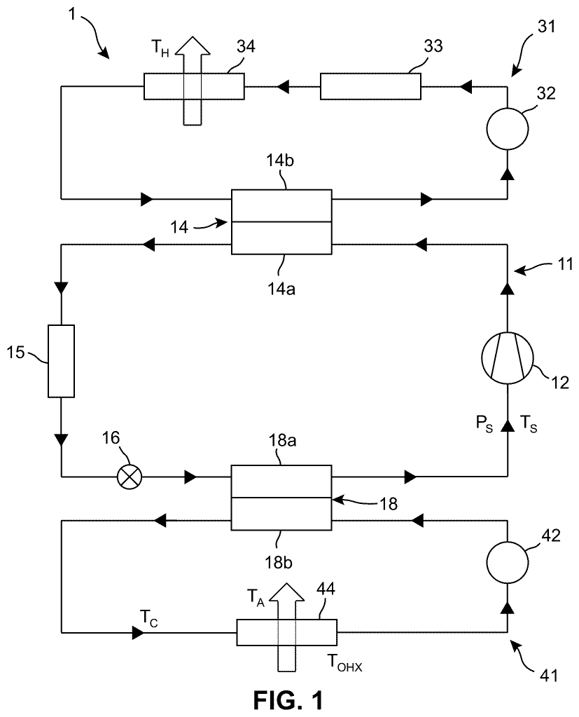

The aforementioned sensors monitoring various temperatures associated with the heat pump system 101 may also be utilized to ensure that the temperature of the refrigerant passing through the refrigerant side 18a of the chiller 18 remains lower than that of the second coolant passing through the coolant side 18b of the chiller 18 to ensure that heat can still be drawn from the ambient air for heating the refrigerant within the refrigerant circuit 111 via the chiller 18, which further aids in increasing the suction temperature T_{S} and thus the heat delivered to the passenger cabin via the first coolant circuit 31 during operation of the compressor 12 at a higher speed (RPM). The improvement to the heating capacity of the heat pump system 101 via the disclosed features may accordingly lead to the removal of auxiliary devices for adding such heat, such as the auxiliary heating device 33 as shown with respect to the heat pump system 1 of FIG. 1, thereby saving cost and reducing complexity with respect to implementation of the heat pump system 101.

The present invention may be best utilized under especially cold ambient temperatures, such as below 8° C., as one example. When the valve 22 and thus the bypass flow path 20 is closed, the compressor 12 may be operated at a maximum possible speed (RPM) until the temperature of the OHX 44 is determined to reach a predetermined value associated with potential freezing thereof. At this point, the valve 22 may be opened to allow for flow through the bypass flow path 20 and the refrigerant entering the chiller 18 may thus be heated and increased in pressure as described above. The described sensors may then be utilized to continue to monitor the temperature difference present between the temperature T_{C} of the second coolant when reaching the OHX 44 and the temperature T_{A} of the ambient air, such as maintaining the second coolant about 1-5° C. cooler than the ambient air temperature T_{A}, to ensure that heat is removed from the ambient air while also preventing icing of the OHX 44. For example, a target value of about 5° C. may be utilized for the value at which the measured ambient air temperature T_{A} is to exceed the temperature of the second coolant T_{C} via the control of the heat pump system 101, such as the expansion element 16, the bypass valve 22, or the compressor 12 via an adjustment in speed thereof. In similar fashion and for the same reasons, a target value of about 1-5° C. may also be utilized as the value at which the suction temperature T_{S} of the refrigerant is maintained below the ambient air temperature T_{A} in achieving the desired temperature difference between the second coolant T_{C} and the ambient air temperature T_{A}. The compressor 12 speed may be increased as much as possible while maintaining the described temperature differential to maintain a maximized heating capacity of the heat pump system 101 throughout use of the hot gas bypass feature.

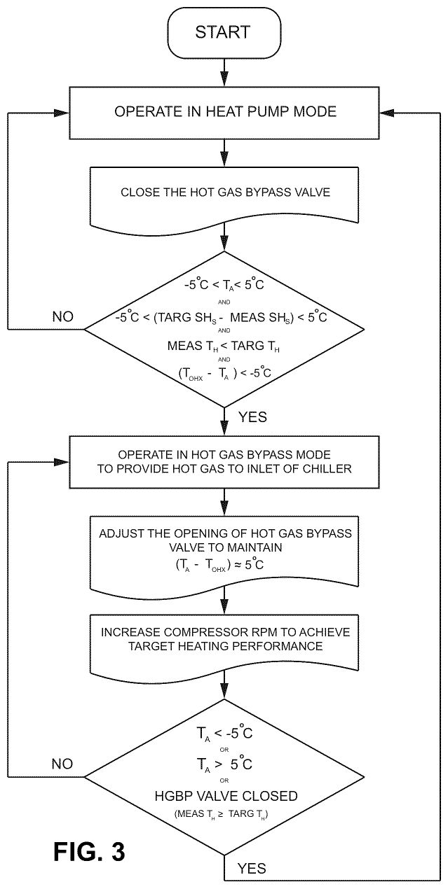

FIG. 3 includes a flow chart describing one exemplary set of conditions under which operation of the disclosed heat pump system 101 of FIG. 2 may occur in accordance with the above-described method of operation. It should be appreciated that different temperature values may be utilized than those shown and described with reference to FIG. 3 while remaining within the scope of the present invention, so long as the same concepts are utilized in increasing the efficiency of the heat pump system 101 in the manner generally disclosed. That is, the prescribed ranges of temperatures at which certain determinations are indicated as being made are not necessarily limited to the exact values provided, and thus may be adjusted accordingly, as desired.

For example, many determinations proposed herein relate to temperature values or differences of 5° C. or −5° C., but these values are not limiting to the present invention, and instead such temperatures correspond to values reasonably encapsulating the circumstances likely to be faced by the heat pump system 101 when encountering real-world ambient conditions and heat pump system conditions. The values are in some circumstances selected to correspond to temperatures close to the freezing point of water such that it can be ensured that appropriate thermal regulation occurs via use of the heat pump system 101 prior to an undesirable event occurring, such as freezing occurring on a surface of the OHX 44, hence alternative values close to 0° C., either positive or negative as the circumstances may warrant, may be selected in carrying out the control scheme represented by FIG. 3 while remaining within the scope of the present invention. In other circumstances, such values may relate to a magnitude of the range of suitable temperatures allowable for a certain condition to be met or not, which may be selected to ensure substantially steady state operation of the heat pump system 101 in a desirable fashion prior to or following an action taking place. Again, such a range of acceptable values may be adjusted to a tighter ranger or broader range of values without necessarily departing from the scope of the present invention, so long as operation of the heat pump system 101 is not negatively impacted by selection of a range of values that is too narrow or too broad. Ranges that are expressed in a manner that is symmetric about 0° C., such as being between −5° C. and 5° C., also need not necessarily be symmetric, and may include differing absolute values, such as including a range between −7° C. and 3° C., as one non-limiting example.

The method according to FIG. 3 may be executed by the controller of the heat pump system 101, which receives sensor data, performs determinations, and operates or actuates the various components of the system 101 accordingly, such as the compressor 12, the expansion element 16, and the bypass valve 22. The disclosed control strategy is intended to dynamically determine whether to operate in a heat pump mode or in a hot gas bypass mode in order to improve compressor performance and prevent icing at the OHX 44 during low ambient temperature conditions. The exemplary logic shown may be implemented in software or firmware executed by the controller, and various modifications and variations of the specific logic flow shown may be made while remaining within the scope of the present invention.

The method begins with the heat pump system 101 normally operating in the heat pump mode of operation, during which the bypass valve 22 remains closed and the refrigerant circulates exclusively through the primary loop of the refrigerant circuit 11. From this circumstance, the controller monitors various temperature values to determine whether to switch into the hot gas bypass mode according to one or more of a plurality of possible conditions being met. A first determination that may be made by the controller with respect to a first condition is whether the measured ambient air temperature T_{A} falls within a range of temperature values, which in the present embodiment includes T_{A} being both greater than −5° C. and less than 5° C. The first determination accordingly determines whether ambient conditions are such that freezing may occur with respect to externally disposed components such as the OHX 44.

A second determination that may be made by the controller with respect to a second condition is whether the measured suction superheat SH_{S} is within a prescribed deviation from a target suction superheat value. In this embodiment, this determination is made by evaluating whether the difference between the measured suction superheat SH_{S} and the target suction superheat is between −5° C. and 5° C. If this condition is not satisfied, such that the measured suction superheat deviates from the target by more than +5° C., then the system continues operating in the heat pump mode and does not initiate the hot gas bypass mode.

A third disclosed determination with respect to a third condition includes a determination of whether the measured temperature T_{H} of the heated air delivered to the passenger cabin is less than a target temperature T_{H} for achieving desirable conditions within the passenger cabin.

The method further discloses the use of a fourth determination with respect to a fourth condition by determining whether the ambient air temperature T_{A} is instantaneously more than 5° C. greater than the measured OHX temperature T_{OHX}, where said condition is alternatively expressed in FIG. 3 as whether the value of the measured OHX temperature T_{OHX} minus the measured ambient air temperature T_{A} is less than −5° C. This comparison is relevant because a significantly lower temperature at the OHX 44 relative to the ambient air temperature may indicate the onset of frost or ice accumulation at the OHX 44, which could impair heat absorption efficiency and necessitate the initiation of hot gas bypass mode to raise the temperature of the second coolant and mitigate icing risk.

The flow chart of FIG. 3 indicates that when all of the foregoing conditions are satisfied the controller determines that the system should enter hot gas bypass mode. However, as mentioned previously, it is conceivable that only some of the conditions disclosed in FIG. 3 may be utilized in making such a determination without necessarily departing from the scope of the present invention. Alternatively, additional conditions or altered conditions may be required to be met from those disclosed without necessarily departing from the scope of the present invention, depending on the specific circumstances.

As noted in FIG. 3, the bypass valve 22 is accordingly at least partially opened to allow high temperature, high pressure refrigerant to flow directly from the discharge of the compressor 12 into the refrigerant side 18a of the chiller 18 downstream of the expansion element 16. As described earlier with respect to FIG. 2, this raises the suction temperature T_{S} and suction pressure P_{S} of the refrigerant entering the compressor 12, improves compressor operating efficiency, and increases the temperature of the second coolant entering the OHX 44 via heat transferred at the chiller 18, thereby reducing the risk of freezing of the OHX 44. The above-described circumstances also lead to the ability for the compressor 12 to be operated at an increased speed (RPM) to achieve a target heating performance of the heat pump system 101 with respect to the desired temperature T_{H} of the heated air delivered to the passenger cabin. The method accordingly includes an upward adjustment of the compressor speed where necessary in accordance with the desired conditions of the passenger within the corresponding passenger cabin.

The heating of the OHX 44 via the hot gas bypass mode of operation may include the adjustment of the bypass valve 22 to maintain a control target of the measured ambient air temperature T_{A} exceeding the measured temperature T_{OHX} of the OHX 44 by a target temperature difference value, such as about 5° C. This may be achieved by maintaining the temperatures T_{C} and T_{S} at the desired respective values thereof relative to the ambient air temperature T_{A} for initiating desirable heat exchange as described herein. The controller may also continue to monitor the measured suction superheat SH_{S} and may utilize an adjustment of the expansion element 16 to achieve the desired value of SH_{S} during operation in the hot gas bypass mode of operation.

Once in the hot gas bypass mode as described above, the method continues with a monitoring loop that evaluates when at least one condition is met to permit a return to the normal heat pump mode via the determinations of the controller. In FIG. 3, three different conditions are listed in the alternative as being suitable for discontinuing the hot gas bypass mode and returning to the heat pump mode. Such conditions include whether the ambient air temperature T_{A} has fallen below the lower value of −5° C., whether the ambient air temperature T_{A} has risen above the higher value of 5° C., or whether the bypass valve 22 is in a closed state indicative of the measured temperature T_{H} of the heated air delivered to the passenger cabin having met or exceeded the target temperature T_{H}. Another specific condition that may be monitored, but that is not listed in FIG. 3, may be where the controller monitors whether the OHX temperature T_{OHX} itself rises above 5° C. such that an icing risk is mitigated. When any of the proposed conditions is satisfied, the bypass valve 22 is closed (or maintained in a detected closed state) and the system reverts to the heat pump mode of operation. As another possible outcome, the hot gas bypass mode of operation may also be ceased where the passenger of the vehicle deactivates the heat pump mode of operation that led to the initiation of the hot gas bypass feature.

In some embodiments, one or more of the conditions described herein may be required to persist for a defined period of time before a transition between operating modes is triggered, to ensure that transient fluctuations do not lead to undesired switching behavior. For example, the controller may require that the heat pump mode of operation has been initiated for a set period of time before a switch to the hot gas bypass mode may be possible, and may further require that the corresponding set of conditions corresponding to the measured temperatures values and differences all continue for the set period of time before the controller initiates a change in the selected mode of operation between the heat pump mode of operation or the hot gas bypass mode of operation. Any reasonable time period may be utilized, such as requiring each condition to be met for 1-10 seconds consecutively, as one non-limiting example. Some time periods, such as the time period for which the temperature T_{OHX} of the OHX 44 exceeds a preselected value (5° C. in the present example) according to the alternative conditions mentioned above, may be selected to be longer to ensure continued icing mitigation along the OHX 44.

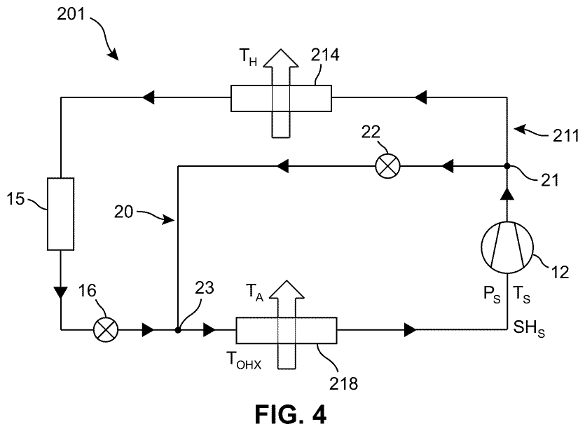

Referring now to FIG. 4, a heat pump system 201 according to another embodiment of the present invention is disclosed, wherein the heat pump system 201 differs from the heat pump system 101 via use of a refrigerant circuit 211 that does not utilize heat exchange communication with the additional coolant circuits 31, 41 to regulate the temperature within the passenger cabin as disclosed with reference to the heat pump systems 1, 101 thus far shown and described. This arrangement may be considered to be a more traditional automotive HVAC system as may be utilized within a vehicle having an internal combustion engine (ICE). The heat pump system 201 includes those components that are common to the heat pump systems 1, 101 as including the same reference characters to indicate that such components operate in the same manner with respect to the heat pump system 201 and thus require no further explanation herein unless indicated otherwise.

As noted above, instead of the refrigerant being in heat exchange communication with the first coolant, a condenser 214 of the refrigerant circuit 211 includes the refrigerant in heat exchange communication with the air delivered to the passenger cabin when heating is delivered thereto. Also, instead of being in heat exchange communication with the second coolant, the refrigerant passing through a chiller 218 of the refrigerant circuit 211 is in heat exchange communication with the ambient air such that the chiller 218 may be representative of the outside heat exchanger of the heat pump system 201 and is accordingly labeled with a measured temperature of T_{OHX} for properly associating operation of the heat pump system 201 with the methods of operation described with respect to the heat pump system 101. The refrigerant circuit 211 operates based on similar principles to the refrigerant circuit 111 but eliminates the intermediary coolants in achieving similar heat exchange relationships in several respects.

The heat pump system 201 may be operated according to the same control schemes as disclosed in describing FIGS. 2 and 3 via replacement of the temperature T_{OHX} of the chiller 218 with the temperature T_{OHX} of the OHX 44 to achieve the same results as described above. The heating of the chiller 218 via the hot gas bypass mode of operation may include the adjustment of the bypass valve 22 to maintain a control target of the measured ambient air temperature T_{A} exceeding the measured temperature T_{OHX} of the chiller 218 by a target temperature difference value, such as about 5° C. This may be achieved by maintaining the temperature T_{S} at the desired value relative to the ambient air temperature T_{A} for initiating desirable heat exchange as described above. The controller may also continue to monitor the measured suction superheat SH_{S} and may utilize an adjustment of the expansion element 16 to achieve a desired value of SH_{S} during operation in the hot gas bypass mode of operation of the heat pump system 201. The compressor 12 may be increased in speed (RPM) in accordance with the necessary heating capacity of the heat pump system 201 in meeting the desired value of T_{H} of the air for heating the passenger cabin. The heat pump system 201 accordingly eliminates the need for auxiliary heating devices via the improved efficiency of the compressor 12 in operating the heat pump system 201 and heating the air passing through the condenser 214 even where ambient conditions are especially cold.

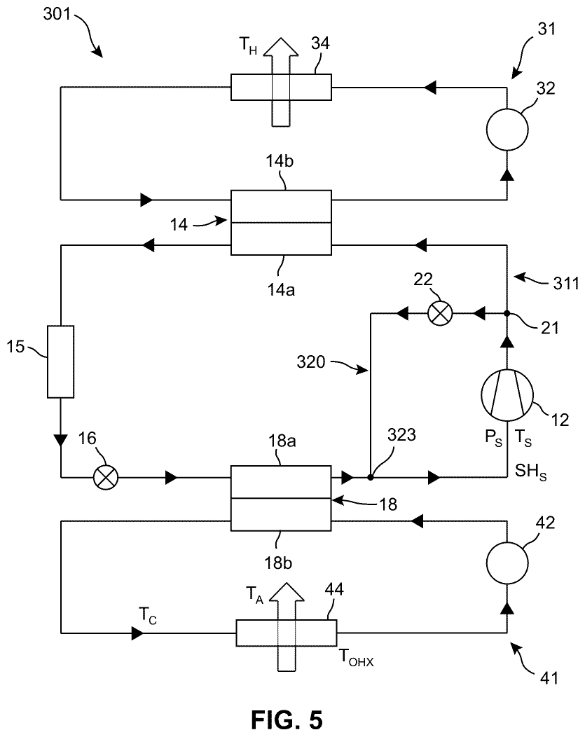

Referring now to FIG. 5, a heat pump system 301 according to another embodiment of the present invention is disclosed, wherein the heat pump system 301 is substantially identical to the heat pump system 101 in configuration with the exception of the inclusion of a modified bypass flow path 320 extending to a repositioned reentry point 323. The heat pump system 301 is shown and described hereinafter with the same reference numerals representing those components having a similar configuration and function to those disclosed with respect to the heat pump system 101, hence further description is omitted hereinafter. The heat pump system 301 generally includes a modified refrigerant circuit 311 from which the bypass flow path 320 extends and reenters, the first coolant circuit 31 is in heat exchange communication with the refrigerant circuit 311, and the second coolant circuit 41 is in heat exchange communication with the refrigerant circuit 311.

The modified bypass flow path 320 is disposed along the refrigerant circuit 311 such that the refrigerant can selectively flow therealong after having exited a discharge end of the compressor 12 with the refrigerant bypassing the condenser 14, the RD 15, the expansion element 16, and the chiller 18 to rejoin the primary loop upstream of the suction end of the compressor 12 while still provided as a relatively high temperature and high pressure gas. The bypass flow path 320 flows from the first branch point 21 of the primary loop disposed downstream of the discharge end of the compressor 12 and upstream of the condenser 14 to a modified (post-chiller) reentry point 323 of the primary loop disposed downstream of the chiller 18 and upstream of the suction end of the compressor 12. The bypass flow path 320 includes the bypass valve 22 therealong for controlling a flow of the refrigerant exiting the compressor 12 and flowing through the bypass flow path 320. The bypass valve 22 may again be an expansion valve that is variably adjustable to adjust a flow cross-section through the valve 22, and therefore a flow rate of the refrigerant flowing through the valve 22. The valve 22 may be adjustable to be fully closed, partially open at any number of intermediate positions, and fully open for allow for maximized flow therethrough. The adjustment of the valve 22 may also be performed to adjust the temperature and pressure of the refrigerant exiting the valve 22 and reaching the reentry point 323 for passage through the compressor 12, as needed.

The heat pump system 301 operates as follows upon the opening of the bypass flow path 320 via the valve 22 being at least partially opened to allow for flow of the high temperature and pressure refrigerant from the branch point 21 to the reentry point 323 for reentry into the suction end of the compressor 12. The refrigerant flows through the bypass flow path 320 and joins the refrigerant exiting the chiller 18 along the primary loop of the refrigerant circuit 311, which has previously been reduced in temperature and pressure via the condenser 14 and the expansion element 16. The relatively high temperature and high pressure refrigerant from the bypass flow path 320 accordingly increases the pressure (and heats) the refrigerant exiting the refrigerant side 18a of the chiller 18 such that the pressure of the refrigerant entering the suction end of the compressor 12 is increased relative to operation of the refrigerant circuit 311 absent flow of the refrigerant through the bypass flow path 320. This increased suction pressure of the refrigerant allows for the compressor 12 to be operated at a greater speed (RPM) for increasing the temperature of the refrigerant at the condenser 14, thereby increasing the heat delivered to the passenger cabin via the first coolant and the heater core 34 of the first coolant circuit 31. The use of the bypass flow path 320 accordingly increases the heating capacity of the heat pump system 301. The increase to the heating capacity of the heat pump system 301 via the disclosed features may accordingly lead to the removal of auxiliary devices for adding such heat, thereby saving cost and reducing complexity.

The controller may operate the heat pump system 301 such that the measured suction pressure P_{S} is adjusted to be maintained at or above a preselected pressure value below which operation of the compressor 12 may be deemed to be inefficient or otherwise incapable of operating at a speed and with corresponding flow rate required for generating the heat necessary in achieving the desired air temperature T_{H}. That is, the valve 22 may be adjustable to increase the suction pressure or maintain the suction pressure to be above a predefined value, such as a value between 0.85 bar to 1.0 bar, via selective use of the bypass flow path 320. This preselected value may be associated with desirable operation of the compressor 12 at the speed needed to meet the heating demands of the heat pump system 301 and/or with the necessary operation of the compressor 12 to ensure desirable oil distribution within the compressor 12 during operation under such conditions.

The hot gas bypass feature of the heat pump system 301 may be optimally utilized under especially cold ambient temperatures, such as below 20° C. When the valve 22 and thus the bypass flow path 320 is closed, the compressor 12 may be operated at a maximum possible speed (RPM) until the suction pressure P_{S} is determined to drop below a predetermined value, such as the aforementioned non-limiting range of this predetermined value being inclusive of or between 0.85 bar to 1 bar. At this point, the valve 22 may be opened to allow for flow through the bypass flow path 320 and the refrigerant exiting the chiller 18 may thus be heated and increased in pressure as described above via entry of the hot gaseous refrigerant into the reentry point 323. The disclosed sensors may then be utilized to continue to monitor the suction pressure P_{S} and to operate the valve 22 to maintain the suction pressure P_{S} above the predetermined value. This enables the refrigerant to continue to absorb heat from the ambient air while preventing the suction pressure P_{S} from falling below the predetermined value.

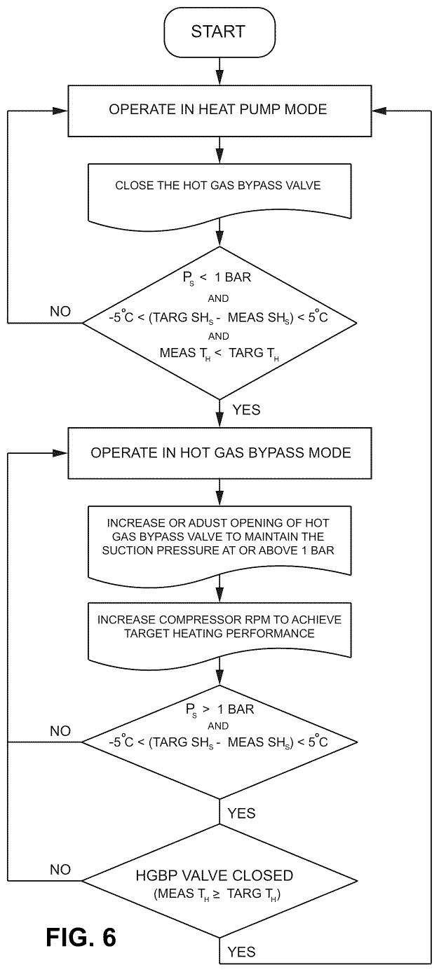

FIG. 6 includes a flow chart describing one exemplary set of conditions under which operation of the disclosed hot gas bypass mode of the heat pump system 301 of FIG. 5 may occur in accordance with the above-described method of operation of the heat pump system 301. It again should be appreciated that different temperature or pressure values may be utilized than those shown and described in FIG. 6 while remaining within the scope of the present invention, so long as the same concepts are utilized in increasing the efficiency of the heat pump system 301 in the manner generally disclosed. That is, the prescribed ranges of temperatures or pressures at which certain determinations are indicated as being made are not necessarily limited to the exact values provided, and thus may be adjusted accordingly, as desired.

The method according to FIG. 6 may be executed by the controller of the heat pump system 301, which receives sensor data, performs determinations, and operates or actuates the various components of the system 301 accordingly, such as the compressor 12, the expansion element 16, and the bypass valve 22. The disclosed control strategy is intended to dynamically determine whether to operate in a heat pump mode or in a hot gas bypass mode in order to improve compressor performance and prevent icing at the OHX 44 during low ambient temperature conditions. The exemplary logic shown may be implemented in software or firmware executed by the controller, and various modifications and variations of the specific logic flow shown may be made while still remaining within the scope of the present invention.

The method begins with the heat pump system 301 normally operating in the heat pump mode of operation, during which the bypass valve 22 remains closed and the refrigerant circulates exclusively through the primary loop of the refrigerant circuit 311. From this circumstance, the controller monitors various temperature and pressure values to determine whether to switch into the hot gas bypass mode according to one or more of a plurality of possible conditions being met. A first determination that may be made by the controller with respect to a first condition is whether the measured suction superheat SH_{S} is within a prescribed deviation from a target suction superheat value. In this embodiment, this determination is made by evaluating whether the difference between the measured suction superheat SH_{S} and the target suction superheat is between −5° C. and 5° C. If this condition is not satisfied, such that the measured suction superheat deviates from the target by more than +5° C., then the system 301 continues operating in the heat pump mode and does not initiate the hot gas bypass mode.

The method further discloses the use of a second determination with respect to a second condition by determining whether the measured suction pressure P_{S} is below the predetermined pressure value, which in the logic of FIG. 6 includes the use of the value of 1 bar as the predetermined pressure value forming the lower limit of acceptable values.

A third disclosed determination with respect to a third condition includes a determination of whether the measured temperature T_{H} of the heated air being delivered to the passenger cabin is less than a target temperature of the heated air in a manner indicative of the inability of the heat pump system 301 to meet the desired heating demands of the passenger via exclusive use of the heat pump mode of operation when faced with the given circumstances.

The flow chart of FIG. 6 indicates that when all of the foregoing conditions are satisfied the controller determines that the system should enter hot gas bypass mode. However, as mentioned previously, it is conceivable that only some of the conditions disclosed in FIG. 6 may be utilized without necessarily departing from the scope of the present invention. Alternatively, additional conditions may be required to be met from those disclosed, such as requiring the ambient air temperature to be below a predetermined value indicative of lower heat capacity of the heat pump system 301, such as the ambient air temperature T_{A} being measured as below 20° C., as one non-limiting example.

The use of the bypass flow path 320 raises the suction temperature T_{S} and suction pressure P_{S} of the refrigerant entering the compressor 12 and thus improves compressor operating efficiency. The above-described circumstances lead to the ability for the compressor 12 to be operated at an increased speed (RPM) to achieve a target heating performance of the heat pump system 301 with respect to the target temperature T_{H} of the heated air delivered to the passenger cabin. The method accordingly includes an upward adjustment of the compressor speed where necessary in accordance with the desired conditions of the passenger within the corresponding passenger cabin.

The use of the hot gas bypass mode of operation may include the adjustment of the bypass valve 22 to maintain a control target of the measured suction pressure P_{S} continuing to exceed the predetermined limiting pressure value, such as 1 bar, to ensure continued desirable operation of the compressor 12 throughout use of the hot gas bypass mode. The expansion element 16 can also continue to be adjusted in order to control the measured suction superheat SH_{S} towards the target suction superheat value during operation in the hot gas bypass mode.

Once in the hot gas bypass mode as described above, the method continues with a monitoring loop that evaluates when at least one condition is met to permit a return to the normal heat pump mode. In FIG. 6, three different conditions are identified as being necessary in conjunction to return to the heat pump mode. However, as noted above with respect to the sets of conditions listed in the flow chart of FIG. 3, any subset of the listed conditions or any additional conditions disclosed elsewhere in this document may be utilized where consistent with the described benefits of the present invention such that any given listing of conditions in FIG. 6 is not limiting to the present disclosure.

According to FIG. 6, a first determination that may be made by the controller with respect to a first condition for ceasing the hot gas bypass mode is whether the measured suction superheat SH_{S} is within a prescribed deviation from a target suction superheat value. In this embodiment, this determination is made by evaluating whether the difference between the measured suction superheat SH_{S} and the target suction superheat is between −5° C. and 5° C. If this condition is not satisfied, such that the measured suction superheat deviates from the target by more than +5° C., then the system 301 continues operating in the hot gas bypass mode.

The method further discloses the use of a second determination with respect to a second condition for ceasing the hot gas bypass mode by determining whether the measured suction pressure P_{S} is now above the predetermined pressure value, which in the logic of FIG. 6 includes the use of the value of 1 bar as the predetermined pressure value above which the pressure must be measured. Again, the hot gas bypass mode is maintained where the suction pressure P_{S} is not at or above the predetermined pressure value.

A third disclosed determination with respect to a third condition for ceasing the hot gas bypass mode includes a determination of whether the measured temperature T_{H} of the heated air being delivered to the passenger cabin is now at or above the target temperature of the heated air in a manner indicative of the heat pump system 301 meeting the desired heating demands of the passenger via the added heat capacity provided by the use of the hot gas bypass flow path 320. As indicated in FIG. 6, the third determination may occur only upon the first and second conditions already having been determined to be met such that two distinct determinations may be made in series in ascertaining whether all three conditions are met.

In some embodiments, one or more of the conditions described herein may be required to persist for a defined period of time before a transition between operating modes is triggered, to ensure that transient fluctuations do not lead to undesired switching behavior. For example, the controller may require that the heat pump mode of operation has been initiated for a set period of time before a switch to the hot gas bypass mode may be possible, and may further require that the corresponding set of conditions corresponding to the measured temperatures values and differences and measured pressure values all continue for the set period of time before the controller initiates a change in the selected mode of operation between the heat pump mode of operation or the hot gas bypass mode of operation. Any reasonable time period may be utilized, such as requiring each condition to be met for 1-10 seconds consecutively, as one non-limiting example. Different conditions may also need to be met for different time periods to be deemed as met in accordance with the logic of FIG. 6.

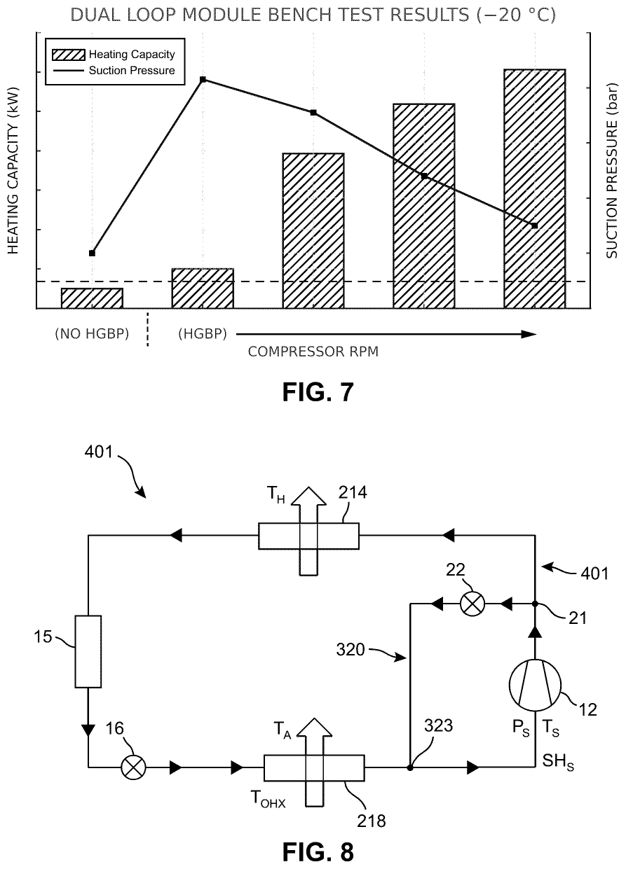

The bench test results illustrated by the chart of FIG. 7 demonstrate the performance characteristics of the dual-loop heat pump system 301 under extremely cold ambient conditions, specifically at −20° C. The chart shows the heating capacity (in kW) and suction pressure P_{S} (in bar) of the system 301 as a function of the compressor speed (RPM), comparing operating conditions with and without activation of the hot gas bypass (HGBP) flow path 320. Please note that specific values are not revealed in FIG. 7, and instead general trends relating to the benefits of the heat pump system 301 are shown via the disclosed relationships. During operation at a relatively low RPM and without hot gas bypass (indicated by a label of “NO HGBP” to the left of a dividing broken line in FIG. 7), the suction pressure was observed to drop to a relatively low value, which is near a predetermined suction pressure limit established for the test below which it is undesirable to operate the compressor 12. In FIG. 7, this lower suction pressure limit is identified by a dashed horizontal line adjacent the bottom of the chart. As mentioned previously, some embodiments may utilize a limit of 1 bar as contemplated by the flow chart of FIG. 6. Once this lower suction pressure limit was approached, further increases in compressor speed were restricted to avoid excessively low suction pressure that could adversely affect compressor performance or reliability.

In subsequent test conditions, the hot gas bypass mode of operation was initiated, allowing controlled injection of high-pressure refrigerant from the discharge side of the compressor 12 into the suction line downstream of the chiller 18. This strategy elevated the suction pressure well above the limiting threshold, thereby enabling the compressor to operate efficiently at relatively higher RPM values (indicated by a label of “HGBP” and an arrow showing increasing compressor RPM values in FIG. 7). As a result of the increased compressor speed and improved refrigerant thermodynamic conditions at the suction inlet of the compressor 12, the system 301 exhibited a notable increase in heating capacity. The graph shows that heating capacity improved progressively as RPM increased under hot gas bypass conditions, underscoring the utility of the bypass flow path 320 in enabling higher system output and more stable operation under low ambient temperature conditions. This test validates the benefit of managing suction pressure through hot gas bypass control to unlock greater thermal output without breaching system operating constraints.

Referring very briefly to FIG. 8, a heat pump system 401 according to another embodiment of the invention is disclosed. The heat pump system 401 is substantially identical to the heat pump system 201 described herein as being suitable for use with an alternative vehicle configuration such as an ICE vehicle and includes the same reference numerals with respect to features sharing the same form and function as disclosed with respect to the heat pump system 401. The heat pump system 401 differs from the heat pump system 201 via the use of a refrigerant circuit 411 having the alternative bypass flow path 320 extending from the branch point 21 to the reentry point 323 positioned downstream of the chiller 218 and upstream of the suction inlet of the compressor 12. It should also be apparent that the same control logic described with respect to the general operation of the heat pump system 301 or as described with respect to the specific control scheme of FIG. 6 may be adapted for use with the heat pump system 401 since the only distinction in operation relates to the manner in which the heat is transferred directly from the refrigerant to the air used to the heat the passenger cabin via the condenser 214 as opposed to using the intermediary of the first coolant to transfer heat to the air delivered to the passenger cabin, which does not require an alteration to the control logic disclosed in FIG. 6.

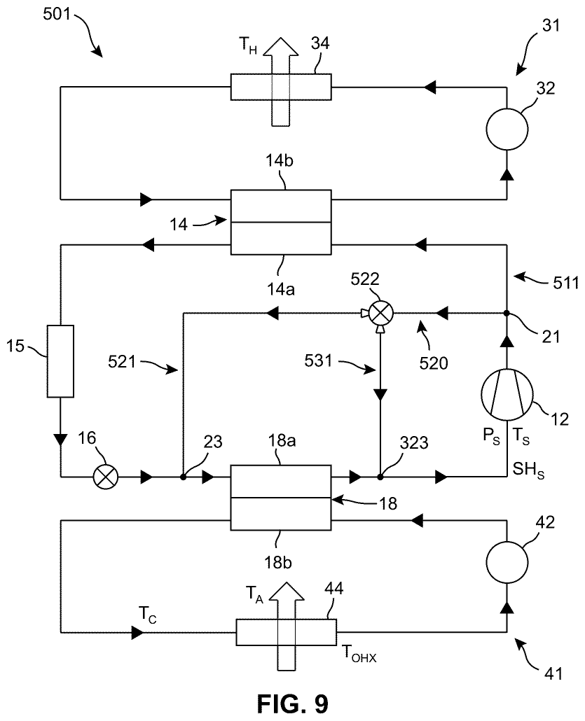

Referring now to FIG. 9, a heat pump system 501 utilizing the combined benefits of the heat pump systems 101, 301 is disclosed, wherein the components found in the heat pump systems 101, 301 that include the same form and function in the heat pump system 501 are again designated with the same reference numerals herein. The heat pump system 501 includes the use of a modified bypass flow path 520 that branches into a first bypass branch 521 leading to the (pre-chiller) reentry point 23 disposed upstream of the chiller 18 and a second bypass branch 531 leading to the (post-chiller) reentry point 323 disposed downstream of the chiller 18. The bypass flow path 520 includes a valve assembly 522 configured to adjust the flow passage therethrough in the same manner as described with reference to the bypass valve 22 while also being capable of switching the bypassed gas from flowing between the first bypass branch 521 and the second bypass branch 531. In the disclosed schematic representation, the valve assembly 522 is formed by a valve 522 having a dual expansion and switching configuration such that the metering of the bypassed gas and the determination of which of the bypass branches 521, 531 receives the bypassed gas may be performed by a common valve structure, which is also be capable of shutting off flow through both of the branches 521, 531 simultaneously for preventing flow through the bypass flow path 520 to either of the reentry points 23, 323. Alternative configurations could include each of the branches 521, 531 having an independently provided bypass valve 22 disposed therealong for selective flow of the bypassed gas through one of the two branches 521, 531 or could include the series disposition of the bypass valve 22 and a subsequent switching valve associated with the branching of the bypass flow path 520 to each of the branches 521, 531 while remaining within the scope of the present invention. Although not disclosed herein, it is also conceivable that the associated valve assembly 522 or integrated valve structure 522 may include the ability to distribute the bypassed gas to both of the reentry points 23, 323 simultaneously without necessarily departing from the scope of the present invention, as desired or necessary for achieving additional control schemes utilizing a combination of the effects of the present invention when operating in either of the disclosed hot gas bypass modes of operation.

The heat pump system 501 operates in the same fashion as the heat pump system 101 when the hot gas is bypassed to the reentry point 23, hence the description of operation of the heat pump system 101 may apply to the heat pump system 501 during use of the reentry point 23, and may further include the use of the control logic disclosed in FIG. 3, or possible variations thereto. The heat pump system 501 similarly operates in the same fashion as the heat pump system 301 when the hot gas is bypassed to the reentry point 323, hence the description of operation of the heat pump system 301 may apply to the heat pump system 501 during use of the reentry point 323, and may further include the use of the control logic disclosed in FIG. 6, or possible variations thereto.

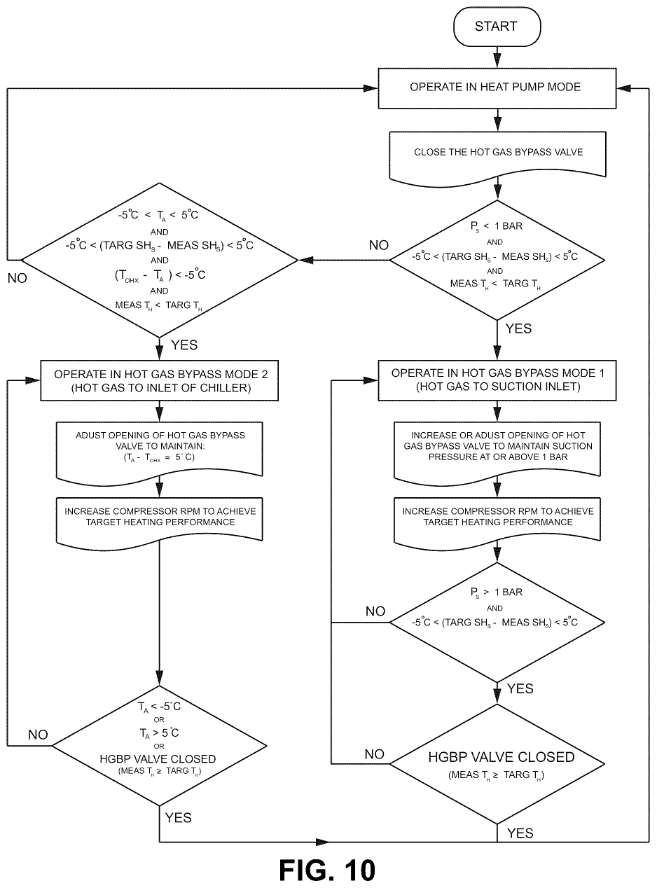

Referring now to FIG. 10, a flow chart is provided that shows one possible control scheme for determining whether to operate the heat pump system 501 according to a first hot gas bypass mode of operation corresponding to gas being bypassed to the reentry point 323 downstream of the chiller 18 or according to a second hot gas bypass mode of operation corresponding to gas being bypassed to the reentry point 23 upstream of the chiller 18. It may be noted that some of the conditions associated with initiating or ceasing the different modes of operation differ slightly from those disclosed in FIGS. 3 and 6 with respect to similar determinations being made on whether to initiate or cease use of the respective hot gas bypass modes of operation. It should be understood that these different conditions thus represent a different set of conditions that may be utilized in making the associated determinations where such differences exist, and are thus representative of additional methods of controlling the respective heat pump systems 101, 201, 301, 401, 501 in a manner consistent with the benefits of the present invention. The present invention is also inclusive of any combination of the listed conditions associated with initiating or ceasing either of the two different hot gas bypass modes of operation as may be distributed between FIG. 10 and the associated one of FIG. 3 or FIG. 6 corresponding to the same hot gas bypass mode of operation. It is also conceivable that conditions that relate to similar concepts, such as various different conditions that are related to potential icing of the OHX 44 or the chiller 218, being utilized in the alternative where only one of the similar conditions must be met to indicate that a corresponding hot gas bypass mode of operation be utilized.

In FIG. 10, following the initiation of the heat pump mode of operation the valve assembly 522 is adjusted to be closed such that no hot gas reaches either of the reentry points 23, 523 and normal operation of the refrigerant circuit 511 may occur. The controller then begins to monitor a first set of conditions with respect to potential initiation of the first mode of hot gas bypass operation and proceeds to initiate the first mode of hot gas bypass operation upon all necessary conditions being so met. FIG. 10 shows the same conditions as being utilized in the initiation of the first mode of hot gas bypass operation as does FIG. 6, hence further discussion is omitted herefrom. When all desired conditions are met, the heat pump system 501 is operated according to the first mode of hot gas bypass operation and the valve assembly 522 delivers the metered hot gas to the reentry point 323 in order to adjust the measured suction pressure P_{S} above the predetermined pressure value (1 bar). The compressor 12 is then increased in speed (RPM) to increase the heating capacity of the heat pump system 501.

FIG. 10 illustrates a slight variation to the logic in ceasing the second mode of hot gas bypass operation in comparison to that disclosed in FIG. 6 via a two-step process where the deviation of the suction superheat SH_{S} and the measured suction pressure P_{S} are first evaluated in the same manner as disclosed in FIG. 6 as a pre-condition to determining whether the measured air temperature T_{H} has reached or exceeded the target air temperature such that the heating capacity of the heat pump system 501 has been improved. Another slight variation may include the controller only opening the valve assembly 522 when the measured temperature T_{H} is below the target temperature such that the valve assembly 522 being closed off from the reentry point 323 is indicative of the target temperature being reached, thereby indicating that the first mode of hot gas bypass operation can be ceased. The method may then proceed back to the operation in the heat pump mode absent the use of the bypass flow path 520.

The flow chart of FIG. 10 indicates that when the first mode of hot gas bypass operation is not utilized the controller monitors whether another independent set of conditions are being met to determine whether to initiate the second mode of hot gas bypass operation where the hot gas is bypassed to the reentry point 23 upstream of the chiller 18. The listed conditions include the deviation of the measured SH_{S} from the target SH_{S} not exceeding 5° C. and the temperature the ambient air exceeds the OHX 44 being more than 5° C. in similar fashion to FIG. 3 and further includes the conditions of determining whether the ambient air temperature T_{A} is between a minimum value (−5° C.) and a maximum value (5° C.) and whether the measured air temperature T_{H} has reached or exceeded the target air temperature. When all desired conditions are met, the controller adjusts the valve assembly 522 to cause the heat pump system 501 to operate in the second mode of hot gas bypass operation with the hot gas being metered to the reentry point 23 in a manner maintaining the temperature of the OHX 44 at a preset value (5° C.) below that of the ambient air temperature T_{A} to maintain desired heat extraction therefrom. The compressor 12 may again be increased in speed (RPM) to improve the heat capacity of the heat pump system 501.

The second mode of hot gas bypass operation is ceased when the measured ambient air temperature T_{A} falls outside of a designated range of temperatures (−5° C. to 5° C.) or when the valve assembly 522 is able to be closed in a manner indicating that the desired heat capacity of the heat pump system 501 has been achieved via the air temperature T_{H} reaching or exceeding the target temperature value. When any of these conditions are satisfied in the alternative, the heat pump system 501 returns back to the normal heat pump mode of operation.

All conditions discussed as occurring with respect to the initiation or the ceasing of any of the disclosed modes of operation may once again be required to occur for a specific predetermined period of time to be deemed as being met to avoid undesired premature mode switching or to ensure steady state operation prior to such mode switching in the same manner as described with reference to previously disclosed heat pump systems 101, 201, 301, 401.

The heat pump system 501 accordingly includes the dynamic adjustment of the hot gas bypass flow path 520 between the pre-chiller reentry point 23 and the post-chiller reentry point 323 based on the monitoring of the designated variables such that system performance can be improved while undesirable effects such as OHX freezing can also be mitigated.

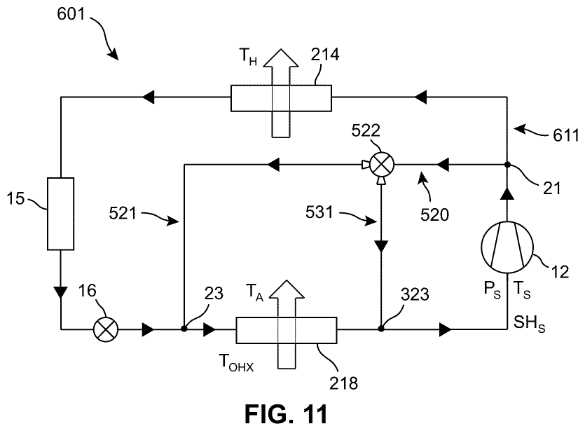

Finally referring very briefly to FIG. 11, a heat pump system 601 is disclosed that is suitable for use in an alternative vehicle configuration such as discussed in describing the heat pump systems 201, 401. The heat pump system 601 includes a refrigerant circuit 611 having the condenser 214, the chiller 218, and the bypass flow path 520. The heat pump system 601 is accordingly able to be operated in accordance with any of the described methods of operation of any described control schemes herein while appreciating the benefits of the present invention, including being controlled according to any of the control schemes disclosed in FIG. 3, FIG. 6, FIG. 10, or combinations or modifications thereto.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A heat pump system comprising:
a refrigerant circuit having a primary loop including, in a direction of flow of a refrigerant through the primary loop, a compressor, a condenser, an expansion element, and a chiller, wherein a bypass flow path extends from a branch point disposed along the primary loop downstream of the compressor and upstream of the condenser to one of:
a pre-chiller reentry point disposed along the primary loop downstream of the expansion element and upstream of the chiller, or
a post-chiller reentry point disposed along the primary loop downstream of the chiller and upstream of a suction inlet of the compressor; and
a bypass valve disposed along the bypass flow path, the bypass valve configured to meter a flow of gaseous refrigerant flowing along the bypass flow path to the corresponding one of the pre-chiller reentry point or the post-chiller reentry point with the flow of the gaseous refrigerant configured to increase a pressure and temperature of the refrigerant along the primary loop at the corresponding one of the pre-chiller reentry point or the post-chiller reentry point.

2. The heat pump system of claim 1, further comprising a coolant circuit circulating a coolant, the coolant circuit including the chiller of the refrigerant circuit and an outside heat exchanger in heat exchange communication with the ambient air.

3. The heat pump system of claim 2, further comprising a controller in signal communication with the bypass valve, the controller being configured to regulate an opening of the bypass valve based on at least one of a measured temperature of the outside heat exchanger or an ambient air temperature.

4. The heat pump system of claim 3, wherein the bypass valve is configured to open when a temperature difference value determined by subtracting the ambient air temperature from the measured temperature of the outside heat exchanger drops below a predetermined temperature value.

5. The heat pump system of claim 1, further comprising a controller in signal communication with the bypass valve, the controller being configured to regulate an opening of the bypass valve based on a measured suction pressure of the compressor.

6. The heat pump system of claim 5, wherein the bypass valve is configured to open when the suction pressure drops below a predetermined pressure value.

7. The heat pump system of claim 1, further comprising a controller in signal communication with the bypass valve, the controller being configured to regulate an opening of the bypass valve based on a measured temperature of air delivered to a passenger cabin of the vehicle.

8. The heat pump system of claim 7, wherein the bypass valve is configured to open when the measured temperature of the air delivered to the passenger cabin is below a target temperature value.

9. The heat pump system of claim 1, wherein the bypass valve is switchable to cause the gaseous refrigerant to flow towards either of the pre-chiller reentry point or the post-chiller reentry point depending on a hot gas bypass mode of operation of the heat pump system.

10. The heat pump system of claim 9, wherein the bypass flow path branches to a first branch leading to the pre-chiller reentry point and a second branch leading to the post-chiller reentry point.

11. A method of operating a heat pump system of a vehicle comprising the steps of:
providing a refrigerant circuit having a primary loop including, in a direction of flow of a refrigerant through the primary loop, a compressor, a condenser, an expansion element, and a chiller, wherein a bypass flow path extends from a branch point disposed along the primary loop downstream of the compressor and upstream of the condenser; and
metering a flow of gaseous refrigerant along the bypass flow path to one of a pre-chiller reentry point disposed along the primary loop downstream of the expansion element and upstream of the chiller or a post-chiller reentry point disposed along the primary loop downstream of the chiller and upstream of a suction inlet of the compressor, wherein the gaseous refrigerant increases a pressure and temperature of the refrigerant along the primary loop at the corresponding one of the pre-chiller reentry point or the post-chiller reentry point to which the gaseous refrigerant is bypassed.

12. The method of claim 11, wherein the step of metering the flow includes opening a bypass valve disposed along the bypass flow path when a suction pressure of the compressor drops below a predetermined pressure value.

13. The method of claim 11, further comprising monitoring a temperature of an outside heat exchanger in heat exchange communication with the refrigerant circuit and initiating the metering of the flow of gaseous refrigerant when the temperature of the outside heat exchanger falls below a predetermined temperature value.

14. The method of claim 11, further comprising monitoring a temperature of an outside heat exchanger in heat exchange communication with the refrigerant circuit and metering the flow of the refrigerant to maintain a temperature of the outside heat exchanger at a preselected temperature value below the ambient air temperature.

15. The method of claim 11, further comprising increasing a speed of the compressor in response to the metering of the flow of the gaseous refrigerant.

16. The method of claim 11, further comprising determining a suction superheat value of the refrigerant upstream of the compressor and adjusting the expansion element to maintain the suction superheat within a predetermined temperature of a target suction superheat value.

17. The method of claim 11, wherein the gaseous refrigerant is metered to the pre-chiller reentry point when an outside heat exchanger in heat exchange communication with the refrigerant circuit is at risk of freezing.

18. The method of claim 11, wherein the gaseous refrigerant is metered to the post-chiller reentry point when a measured suction pressure of the compressor is below a predetermined pressure value.

19. The method of claim 11, further comprising terminating the metering of the flow of gaseous refrigerant when a bypass valve disposed along the bypass flow path is closed.

20. The method of claim 11, wherein the metering of the flow of gaseous refrigerant includes dynamically adjusting a bypass valve disposed along the bypass flow path to maintain a target pressure at the compressor inlet.
